(19) United States
(12) Patent Application Publication
(10) Pub. No.: US 2007/0016821 A1
(43) Pub. Date: Jan. 18, 2007

(54) Method and apparatus to change transmission line impedance

(75) Inventors: David L. Williams, San Jose, CA (US); James P. Kardach, Saratoga, CA (US)

Correspondence Address: FLESHNER-KIM, LLP;INTEL CORPORATION, P.O. BOX 221200, CHANTILLY, VA, 20153-1200, US

(73) Assignee: Intel Corporation

(21) Appl. No.: 11/168,567

(22) Filed: Jun. 29, 2005

(51) Int. Cl. G06F 1/04

(52) U.S. Cl. 713/503

(57) ABSTRACT

For at least one disclosed embodiment, a die may be provided that includes a transmission line (or waveguide) and a signal-generating device to generate a pulse on the transmission line and to receive a pulse from the transmission line. A plurality of transistors may be provided along a length of the transmission line to change an impedance of the transmission line. This may change a speed of the pulse along the transmission line or change an effective length of the transmission line. A control device may also control the plurality of transistors based on a sensed temperature of a thermistor device.

### FIELD

Embodiments of the present invention may relate to dies or chips. More particularly, embodiments of the present invention may relate to a method and apparatus to change (or control) an impedance of a transmission line such as on a die or chip.

### BACKGROUND

Global clock distribution may be provided for multi-gigahertz processors. For example, timing uncertainty may reduce with clock period, whereas skew and jitter may be proportional to latency, which may not scale with clock period. Processor clock oscillators may operate at 5 to 10 GHz, for example. In a clock oscillator, a quartz crystal oscillator may be boosted to very high frequencies by phase lock loops (PLLs). However, this may not be energy efficient. Additionally, approaches of using a chain of inverters may be problematic because a timing delay introduced by each inverter may change with process variation and temperature.

### BRIEF DESCRIPTION OF THE DRAWINGS

The foregoing and a better understanding of embodiments of the present invention may become apparent from the following detailed description of arrangements and/or example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only and embodiments of the invention are not limited thereto.

The following represents brief descriptions of the drawings in which like reference numerals represent like elements and wherein:

FIG. 1 illustrates a clocking distribution network on a die according to an example arrangement;

FIG. 2 illustrates a clocking circuit according to an example arrangement;

FIG. 3 illustrates an impedance changing device according to an example embodiment of the present invention;

FIG. 4 illustrates an impedance changing device according to an example embodiment of the present invention;

FIG. 5 illustrates an impedance changing device according to an example embodiment of the present invention;

FIG. 6 illustrates an impedance changing device according to an example embodiment of the present invention;

FIG. 7 illustrates an impedance changing device according to an example embodiment of the present invention; and

FIG. 8 is a block diagram of a system according to an example embodiment of the present invention.

### DETAILED DESCRIPTION

In the detailed description to follow, example sizes/models/values/ranges may be given although the present invention is not limited to the same. Where specific details are set forth in order to describe example embodiments of the invention, it should be apparent to one skilled in the art that the invention can be practiced without these specific details.

Embodiments of the present invention may provide a die that includes a signal generating device to generate a pulse on a transmission line and a control device to control an impedance on the transmission line. The control device may be coupled to an impedance device (such as transistors) to control the impedance along the transmission line.

Embodiments of the present invention may rely on transmission line properties of traces on a silicon die to perform timing operations. This may allow a transmission line design to be dynamically varied by changing an effective length of the transmission line and/or by changing an impedance of the transmission line. This may be performed dynamically to allow for compensation based on the effects of temperature.

Embodiments of the present invention may cause energy to be stored in a standing wave pattern in a transmission line (or waveguide), which may then behave as a resonant cavity in a microwave circuit. Control of the impedance as a function of position along the transmission line may allow the cavity length to be controlled and/or allow choice of a resonant standing wave pattern. Embodiments of the present invention may further utilize transmission lines to generate a standing wave of known delay.

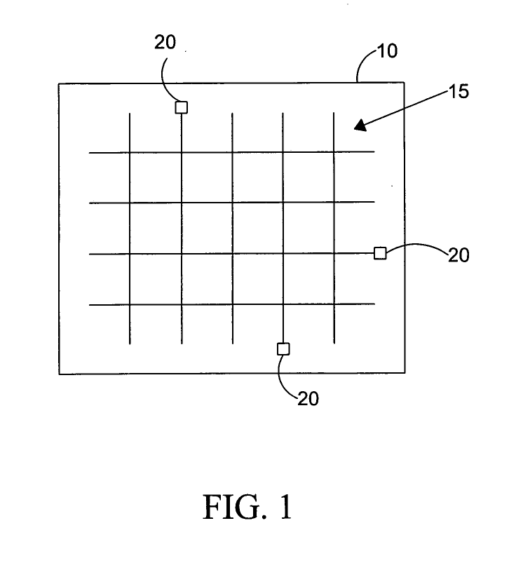

FIG. 1 illustrates a clocking distribution network on a die according to an example arrangement. Other arrangements are also possible. More specifically, FIG. 1 shows a die 10 that includes a clocking distribution network 15 to distribute clock signals to various elements on the die 10 including but not limited to a processor, transistors, etc. The clocking distribution network 15 may include a plurality of transmission lines (or waveguides) distributed about the die 10 to distribute the clock signals. The clocking distribution network 15 may also include a plurality of clocking circuits (shown as elements 20) to provide clock signals, such as standing waves (SW), for example, to specific features on the die. The arrangement of FIG. 1 shows that a plurality of transmission lines and clocking circuits may be provided. The transmission lines and clocking circuits may be provided in any of a number of patterns or arrangements. Various embodiments of clock circuits and transmission lines will be described below. For ease of illustration, like elements and operations in the figures may not be described more than once.

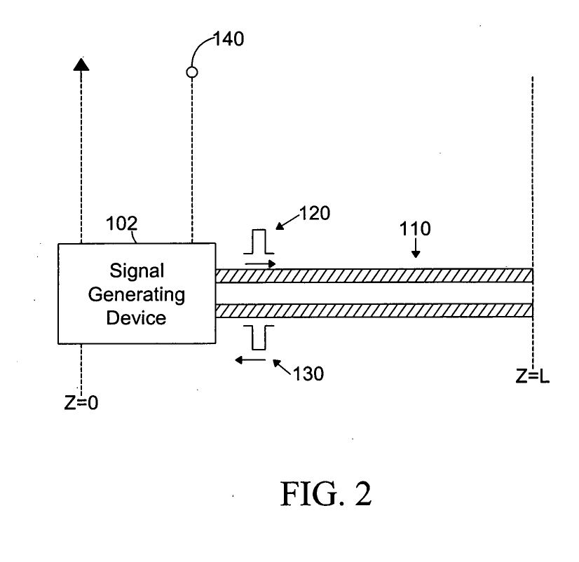

FIG. 2 illustrates a clocking circuit according to an example arrangement. Other arrangements and configurations are also within the scope of the present invention. More specifically, FIG. 2 shows a signal-generating device 102, such as a monostable device, provided at one end of a transmission line 110 (or waveguide). While embodiments of the present invention will hereafter be described with respect to a transmission line 110, embodiments of the present application are also applicable to use with a waveguide.

The transmission line 110 is shown as having a length of approximately L. The signal-generating device 102 operates by generating and sending a square pulse 120 between two traces (or wires) forming the transmission line 110. An electric field may be generated between the two traces to allow the pulses to propagate along the transmission line (without or substantially without interference from outside the transmission line). The pulse 120 travels along the transmission line 110 and is reflected back by a wall or other structure (at Z=L) as a returned pulse 130 between the two traces forming the transmission line 110. When the returned pulse 130 reaches the original beginning of the transmission line 110 (at approximately Z=0), the returned pulse 130 may trigger the signal-generating device 102 to apply (or generate) another pulse 120 on or along the transmission line 110.

FIG. 2 shows the signal-generating device 102 may be directly coupled to the transmission line 110, although embodiments of the present invention are not limited to this disclosure as embodiments of the present invention may provide that the signal-generating device 102 is spaced from the transmission line 110. The same will apply also to the following discussion of signal-generating devices and transmission lines.

FIG. 2 also shows a clock output terminal 140 that receives the pulse 120 either from the signal generating device 102 (as shown) or on the transmission line 110. The clock output terminal 140 provides the generated clock signal which may thereafter be provided to various elements on the die. Accordingly, various features of FIG. 2 (and the other figures) may be considered a clocking circuit. If the generated signal is not a square wave, such as when a standing wave is generated as discussed below, then a Schmitt trigger may be provided at or near the output terminal 140 (or in another area) to form a square wave.

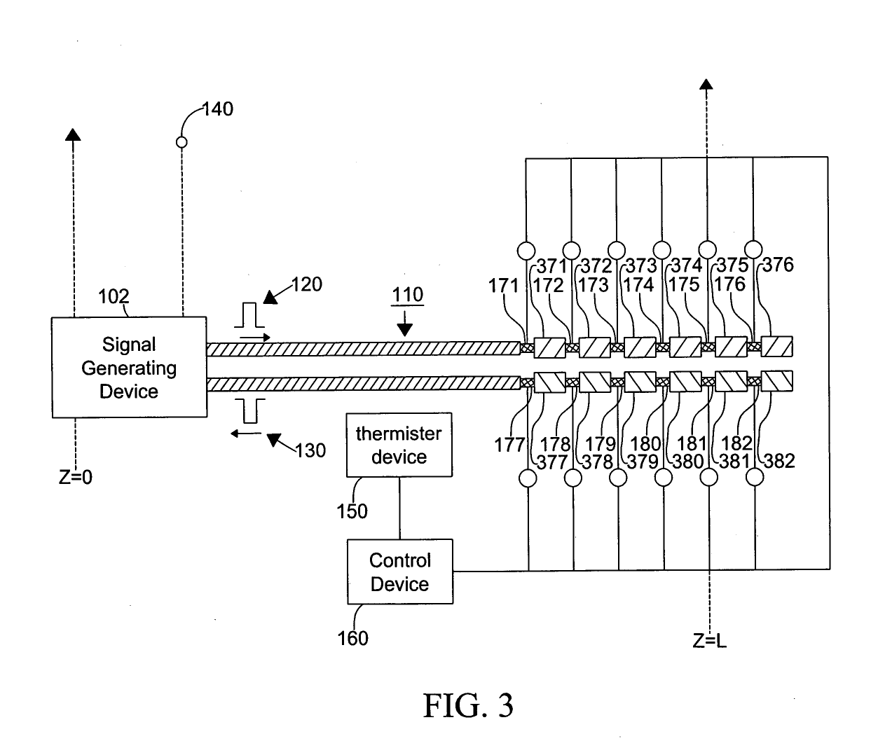

FIG. 3 illustrates an impedance changing device according to an example embodiment of the present invention. Other embodiments and configurations are also within the scope of the present invention. More specifically, FIG. 3 shows the signal-generating device 102, the transmission line 110, a thermistor device 150, a control device 160, a plurality of transistors 171-182 associated with the transmission line 110 and a plurality of transmission line segments 371-382 (or waveguide segments) associated with the transmission line 110. The control device 160 may be coupled to the thermistor device 150 and to each of the transistors 171-182 so as to individually control a state of each of the transistors 171-182.

The transistors 171-182 may be transistors that operate based on the sensed temperature of the thermistor device 150. More specifically, based on the sensed temperature of the thermistor device 150, the control device 160 may provide control signals to control ON/OFF states of each of the transistors 171-182. The ON/OFF states of the transistors may allow corresponding transmission line segments to effectively be added to a length of the transmission line 110. This may accordingly change an impedance of the overall transmission line 110. Stated differently, control signals applied to the transistors 171-182 along the transmission line 110 may control an effective length of the transmission line 110 based on impedance. The transistors 171-182 may therefore be referred to as an impedance device to change or control an impedance of the transmission line (or waveguide).

As one example, the turning ON of transistor 171 allows the transmission line segment 371 to be added ON to the overall length of the transmission line 110. The transmission line segment 371 increases the capacitance of the overall transmission line 110 and therefore increase the impedance of the transmission line 110. Each of the transistors 171-182 may be individually controlled so as to change the impedance of the transmission line. Each of the transistors 171-182 may be associated with one of the transmission line segments 371-382.

The thermistor device 150 may be provided along the length of the transmission line 110 to account for effects of temperature on the signal-generating device 102 and the impedance of the transmission line 110. That is, the impedance of the transmission line 110 may be derived from a change in a dielectric constant of an insulator of the transmission line 110 and a change in conductivity of a trace of the transmission line 110 as a function of temperature. Accordingly, FIG. 3 shows that an effective length of the transmission line 110 may be controlled by switching ON and OFF the transistors 171-182 along the length of the transmission line 110 to compensate for temperature effects. For example, transistors 171-174 and 177-180 may be turned ON to allow pulses to pass along the transmission line segments 371-374 and 377-380. Transistors 175-176 and 181-182 may be turned OFF having a high impedance so as to block pulses from passing along the transmission line 110 onto transmission line segments 375-376 and 381-382. A sharp transition may be provided for the ON state and the OFF state of the transistors so as to maximize the reflection coefficient of the wave. In FIG. 3, the transistor 175-176 and 181-182 are provided in an OFF state so as to allow the pulse 120 to reflect at a position corresponding to Z=L.

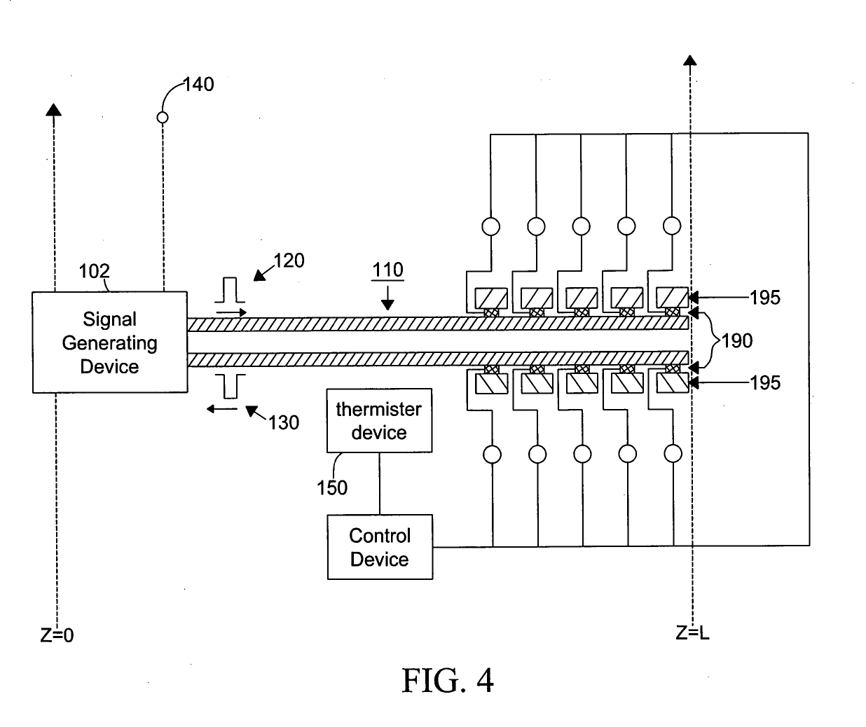

FIG. 4 illustrates an impedance changing device according to an example embodiment of the present invention. Other embodiments and configurations are also within the scope of the present invention. More specifically, FIG. 4 shows the signal-generating device 102, the transmission line 110, the thermistor device 150, the control device 160, a plurality of transistors 190 and a plurality of transmission line segments (or waveguide segments) 195. For illustration purposes, the transistors are collectively shown as element 190 and the transmission line segments are shown as elements 195. In FIG. 4, each transistor may be coupled between the trace of the transmission line 110 and a corresponding one of the transmission line segments. The turning ON of any one of the transistors may change a total impedance of the overall transmission line 110. This may result in a change in a round trip of a pulse (such as a radio frequency RF pulse) propagating along the transmission line.

The control device 160 may be coupled to the thermistor device 150 and to each of the transistors 190 so as to control states of each of the transistors 190. More specifically, based on the sensed temperature of the thermistor device 150, the control device 160 may control states of the transistors 190. In this example embodiment, various one of the transistors 190 may be ON and various ones of the transistors 180 may be OFF. The ON/OFF states may be changed so as to change an impedance of the transmission line 110. Additionally, transistors may be partly turned ON/OFF. This may be done to avoid a sharp interface at an OFF state. A pulse may be reflected due to an OFF state or may slow down due to a partly ON-partly OFF state. Varying voltage levels may be used to control the transistors to be in various states between fully ON and fully OFF. Changing the impedance of the transmission line 110 effectively changes a speed of the propagation of the pulses 120/130 along the transmission line 110. That is, the speed of a pulse traveling along the transmission line 110 may decrease due to higher impedance caused by a transistor being in a partly ON-partly OFF state. The transistors 190 may therefore be referred to as an impedance device to change or control an impedance of the transmission line (or waveguide).

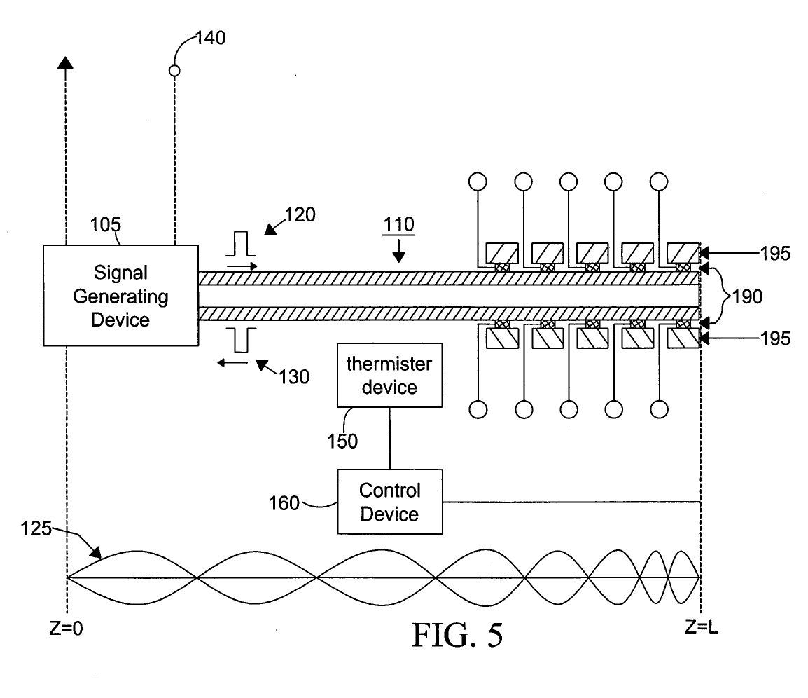

FIG. 5 illustrates an impedance changing device according to an example embodiment of the present invention. Other embodiments and configurations are also within the scope of the present invention. More specifically, FIG. 5 shows a signal-generating device 105 (such as including an inverter circuit, a Schmidt trigger and a notch filter) as well as the thermistor device 150, the control device 160, the plurality of transistors 190 along the transmission line 110 and the plurality of transmission line segments 195. FIG. 5 also shows that a standing wave may be created as shown by waveform 125.

The control device 160 may be coupled to the thermistor device 150 and to each of the transistors 190 so as to control states of the transistors 190. For ease of illustration, FIG. 5 does not show the control device 160 being physically coupled to each of the transistors 190. Similarly as discussed above, the transistors may be coupled between the transmission line 110 and corresponding transmission line segments. Based on the sensed temperature of the thermistor device 150, the control device 160 may control states of the transistors 190. In this example embodiment, the transistors 190 may be controlled by the control device 160 also as a function of position along the transmission line 110. A period of the waveform 125 based on the pulses 120/130 may be controlled based on the impedance of the transmission line (or refractive index). Accordingly, a standing wave may be generated and altered by changing the impedance along the transmission line (and on the transmission line) using the transistors 190. The transistors 190 may therefore be referred to as an impedance device to change or control an impedance of the transmission line (or waveguide). The waveform 125 shows an electric field as a function of position at a snapshot in time in which the impedance is changed over the distance of the transmission line 110 and thus the period may change.

The inverter circuit (shown in the signal-generating device 105) may provide a positive pulse upon receiving a negative pulse. In other words, the negative pulse (corresponding to the pulse 130) received from the transmission line 110 may operate as a trigger to send a positive pulse (corresponding to the pulse 120) along the transmission line 110. In order to provide a square pulse from a generated sinusoidal waveform, a Schmidt trigger may be provided as part of the signal-generating device 105. The notch filter may be an inductance and capacitance (LC) circuit, for example, to deal with harmonics. The notch filter may cause increased losses away from a desired frequency of operation and may be used as a “coarse adjustment” of the generated pulse.

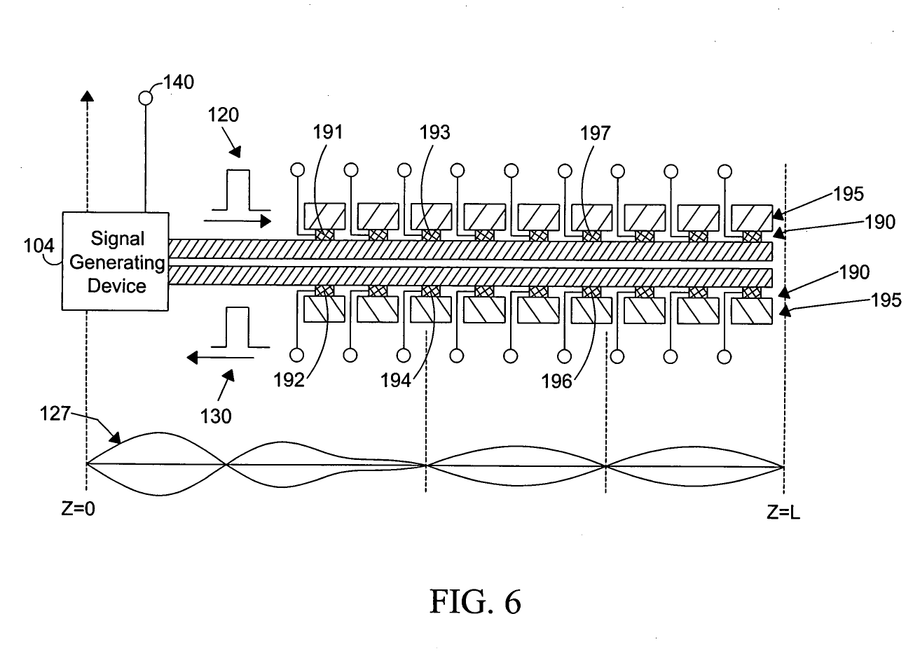

FIG. 6 illustrates an impedance changing device according to an example embodiment of the present invention. Other embodiments and configurations are also within the scope of the present invention. More specifically, FIG. 6 shows the signal-generating device 104, the transmission line 110, the plurality of transistors 190 along the transmission line 110 and the plurality of transmission line segments 195 coupled to corresponding ones of the transistors 190. For ease of illustration, FIG. 6 does not show the control device 160 being physically coupled to each of the transistors 190. Although not shown in FIG. 6, this embodiment may also include the thermistor device 150 and the control device 160. Similarly as discussed above, the control device 160 may operate such that based on the sensed temperature of the thermistor device 150, the control device 160 may control states of the transistors 190 and accordingly can control the impedance of the overall transmission line 110 using the transistors 190 and the transmission line segments 195.

FIG. 6 also shows that a standing wave may be created as shown by waveform 127. A standing wave may be generated and altered by changing an impedance along the transmission line (and on the transmission line) at desired nodes. The waveform 127 shows an electric field as a function of position at a snapshot in time. The waveform 127 is generated and shaped by changing the impedance at various locations along the transmission line 110. For example, transistor 191 may be in an OFF state (or a partially OFF state) and transistor 192 may be in an ON state (or turned ON). This may alter the impedance as shown along the waveform 127 at a location corresponding to the transistors 191, 192. Each of the transistors 193, 194 may be turned OFF (or partially OFF) to create an antinode at a location along the waveform 127 corresponding to the transistors 193, 194. Similarly, each of the transistors 196, 197 may be turned OFF (or partially OFF) to create another antinode at a location along the waveform 127 corresponding to the transistors 196, 197. Accordingly, the transistors 190 allow a waveform to be altered as desired. The transistors 190 may therefore be referred to as an impedance device to change or control an impedance of the transmission line (or waveguide).

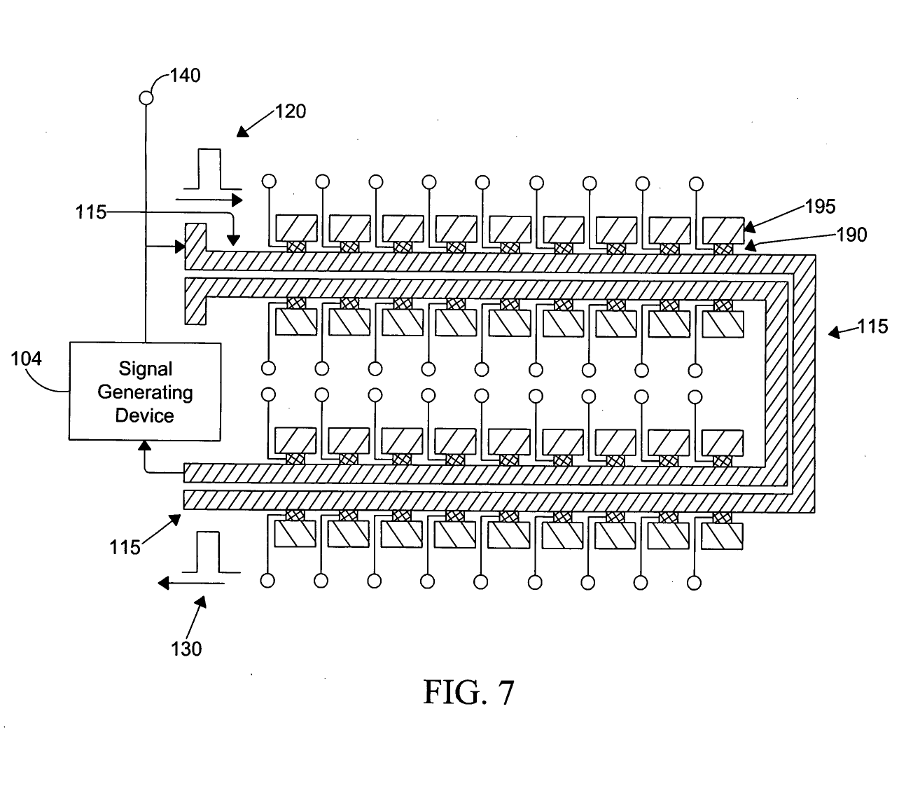

FIG. 7 illustrates an impedance changing device according to an example embodiment of the present invention. Other embodiments and configurations are also within the scope of the present invention. More specifically, FIG. 7 shows the signal-generating device 104, a transmission line 115, the plurality of transistors 190 along the transmission line 115 and the plurality of transmission line segments 195. In this example, the transmission line 115 is in a form of a ring cavity such as around a perimeter of a die, for example. Although not shown in FIG. 7, this embodiment may also include the thermistor device 150 and the control device 160 that may operate such that based on the sensed temperature of the thermistor device 150, the control device 160 may control states of the transistors 190 along the ring cavity. For ease of illustration, FIG. 7 does not show the control device 160 coupled to each of the transistors 190. Additionally, for ease of illustration, the signal generating device 104 is shown spaced from the transmission line 115 although it is understood that the signal generating device 104 may be provided immediately next to the transmission line 115.

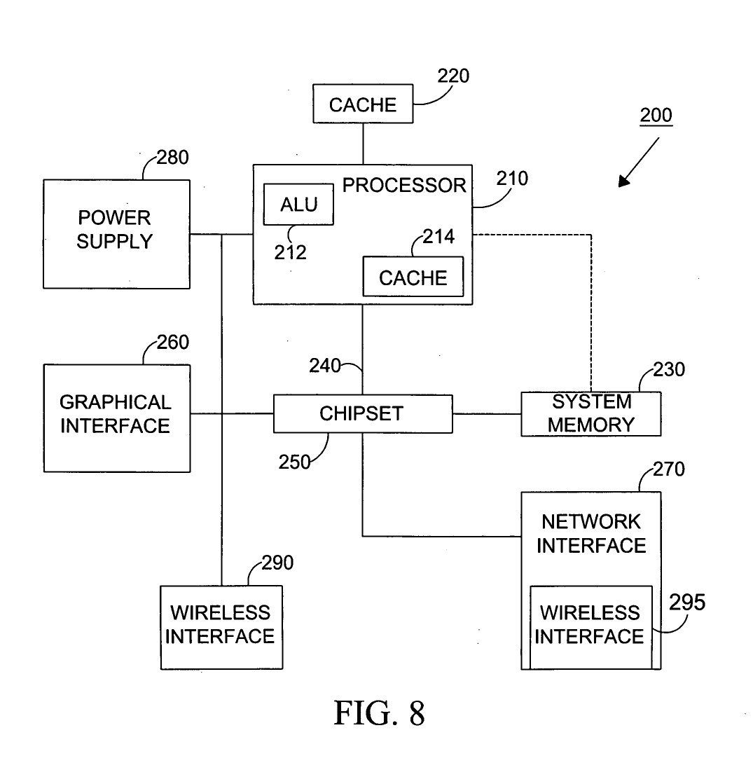

FIG. 8 is a block diagram of a system (such as a computer system 200) according to an example embodiment of the present invention. Other embodiments and configurations are also within the scope of the present invention. More specifically, the computer system 200 may include a processor 210 that may have many sub-blocks such as an arithmetic logic unit (ALU) 212 and an on-die (or internal) cache 214. The processor 210 may also communicate to other levels of cache, such as external cache 220. Higher memory hierarchy levels such as a system memory 230 (or random access memory RAM) may be accessed via a host bus 240 and a chip set 250 (or die). The system memory 230 may also be accessed in other ways, such as directly from the processor 210 (as shown by the dotted line) and/or without passing through the host bus 240 and/or the chip set 250. In addition, other functional units such as a graphical interface 260, such as a graphics accelerator, and a network interface 270, to name just a few, may communicate with the processor 210 via appropriate busses or ports. The processor 210 may be powered by a power supply 280, for example. The system 200 may also include a wireless interface 290, 295 to interface the system 200 with other systems, networks, and/or devices via a wireless connection. The chip set 250 may include a die having an impedance changing device as discussed above with respect to example embodiments of the present invention. For example, the die may include a signal generating device and a control device to control the impedance of a transmission line. The die may further include an impedance device (such as a plurality of transistors) and a transmission line. These features may be referred to as clocking circuits (as discussed above). Embodiments of the present invention are also capable of altering impedance of any transmission line such as input/output line of a die or an integrated circuit.

Systems represented by the various foregoing figures can be of any type. Examples of represented systems include computers (e.g., desktops, laptops, handhelds, servers, tablets, web appliances, routers, etc.), wireless communications devices (e.g., cellular phones, cordless phones, pagers, personal digital assistants, etc.), computer-related peripherals (e.g., printers, scanners, monitors, etc.), entertainment devices (e.g., televisions, radios, stereos, tape and compact disc players, video cassette recorders, camcorders, digital cameras, MP3 (Motion Picture Experts Group, Audio Layer 3) players, video games, watches, etc.), and the like.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A die comprising:
a signal-generating device to generate a pulse on a transmission line; and
a control device to control an impedance of the transmission line.

2. The die of claim 1, further comprising:
a transmission line.

3. The die of claim 1, further comprising:
an impedance device to control an impedance of the transmission line.

4. The die of claim 3, wherein the impedance device comprises a plurality of transistors.

5. The die of claim 4, wherein the impedance device further comprises a plurality of transmission line segments.

6. The die of claim 5, wherein each transistor is coupled between the transmission line and a corresponding one of the transmission line segments.

7. The die of claim 5, wherein each of the transistors is associated with one of the transmission line segment in a manner to extend a length of the transmission line.

8. The die of claim 1, further comprising a thermistor device to sense a temperature along the transmission line.

9. The die of claim 8, wherein the control device to control the impedance device based on the sensed temperature of the thermistor device.

10. The die of claim 1, wherein the impedance device to change a speed of propagation of the wave along the transmission line.

11. The die of claim 1, wherein the impedance device to change an effective length of the transmission line.

12. An apparatus comprising:
a waveguide;
a signal-generating device to provide a clock signal on the waveguide; and
a plurality of transistors coupled to the waveguide to change impedance characteristics of the waveguide.

13. The apparatus of claim 12, further comprising a control device to control the plurality of transistors.

14. The apparatus of claim 13, further comprising a plurality of waveguide segments.

15. The apparatus of claim 14, wherein each transistor is coupled between the waveguide and a corresponding one of the waveguide segments.

16. The apparatus of claim 13, further comprising a thermistor device to sense a temperature along the waveguide.

17. The apparatus of claim 16, wherein the control device to control the transistors based on the sensed temperature of the thermistor device.

18. The apparatus of claim 13, wherein the plurality of transistors to change a speed of propagation of the clock signal along the waveguide.

19. The apparatus of claim 13, wherein the plurality of transistors to change an effective length of the waveguide.

20. A method comprising:
generating a pulse on a transmission line; and
controlling an impedance of the transmission line.

21. The method of claim 20, wherein controlling the impedance comprises activating transistors.

22. The method of claim 20, further comprising:
sensing a temperature along the transmission line.

23. The method of claim 22, wherein controlling the impedance comprises controlling the impedance based on the sensed temperature.

24. An electronic system comprising:
a wireless interface to interface to devices; and
a processor coupled to the wireless interface, the processor having a clocking circuit including:
a transmission line;
a signal-generating device to generate a clock signal on the transmission line; and
an impedance device to control an impedance of the transmission line.

25. The system of claim 24, wherein the impedance device comprises a plurality of transistors and a plurality of transmission line segments.

26. The system of claim 24, the clocking circuit further including a control device to control the impedance device.

27. The system of claim 24, the clocking circuit further including a thermistor device to sense a temperature along the transmission line.
